(19) United States
(12) Patent Application Publication
(10) Pub. No.: US 2026/0271141 A1
(43) Pub. Date: Sep. 10, 2026

(54) INDUCTION WARMING SYSTEM WITH AUTO-ADJUSTING RESONANT CIRCUITRY

(71) Applicant: The Vollrath Company, L.L.C., Sheboygan, WI (US)

(72) Inventors: Don Zahrte, SR., Sheboygan, WI (US); Jeremiah Kopiness, Saukville, WI (US)

(73) Assignee: The Vollrath Company, L.L.C., Sheboygan, WI (US)

(21) Appl. No.: 19/073,969

(22) Filed: Mar. 7, 2025

(51) Int. Cl. H05B 6/08; H02M 7/217; H05B 6/04; H05B 6/06

(52) U.S. Cl. CPC H05B 6/08; H02M 7/217; H05B 6/04; H05B 6/062

(57) ABSTRACT

An auto-adjusting resonant circuitry for induction warming can electrically couple with an induction coil and a switch, control a voltage level of an energy storage device prior to activation of the switch, prevent charging of the energy storage device by the switch responsive to activation of the switch.

### BACKGROUND

The present disclosure relates generally to the field of power conversion circuitry. More specifically, the present disclosure relates to an adjusting resonant converter circuit used to power an inductor in an induction warming system. The induction warming system may use the inductor as a heating element.

### SUMMARY

At least one embodiment relates to an induction warming system. The induction warming system can include an induction coil, a switch, and an auto-adjusting resonant circuitry. The auto-adjusting resonant circuitry can couple to the induction coil and the switch. The auto-adjusting resonant circuitry can control a voltage level of an energy storage device prior to activation of the switch. The energy storage device can provide electrical power to the induction coil with the switch deactivated. The auto-adjusting resonant circuitry can prevent, responsive to controlling the voltage level of the energy storage device, charging of the energy storage device by the switch responsive to activation of the switch.

In some embodiments, the auto-adjusting resonant circuitry can include first circuitry. The first circuitry can couple with a power source. The first circuitry can receive a first voltage included in an alternating current (AC) signal. The first circuitry can convert the AC signal to a direct current (DC) signal. The auto-adjusting resonant circuitry can include second circuitry. The second circuitry can activate the switch to power the induction coil based on the DC signal. The auto-adjusting resonant circuitry can include third circuitry. The third circuitry can control a voltage difference between the voltage level of the energy storage device and the second circuitry prior to controlling the switch to prevent charging of the energy storage device by the switch.

In some embodiments, the second circuitry can deactivate the switch subsequent to a predetermined amount of time. The induction coil can discharge power from the energy storage device causing a decrease in the voltage level of the energy storage device. The third circuitry can charge the energy storage device to offset the decrease in the voltage level of the energy storage device.

In some embodiments, the induction coil can provide current, via a first path, to the energy storage device to charge the energy storage device responsive to deactivation of the switch. The energy storage device can serve as a voltage source responsive to a predetermined amount of time subsequent to deactivation of the switch.

In some embodiments, the auto-adjusting resonant circuitry can provide current to the induction coil via a first path with the switch activated. The auto-adjusting resonant circuitry can provide current to the induction coil via a second path with the switch deactivated. The first path can include current flowing through the switch. The second path can include current flowing through the energy storage device.

In some embodiments, the auto-adjusting resonant circuitry can operate such that a maximum power output provided, by a power source, to the auto-adjusting resonant circuitry is no more than 15% larger than an average power output provided, by the power source, to the auto-adjusting resonant circuitry.

In some embodiments, the auto-adjusting resonant circuitry can operate at a continuous load such that a change in an amount of power, provided by a power source to the auto-adjusting resonant circuitry, is prevented from causing a change in current flowing through the induction coil.

In some embodiments, the induction coil can receive, from the auto-adjusting resonant circuitry, current via a first path with the switch activated. The induction coil can receive, from the auto-adjusting resonant circuitry, current via a second path with the switch deactivated.

At least one embodiment relates to a device. The device can be for an induction warming system. The device can include a switch and an auto-adjusting resonant circuitry. The auto-adjusting resonant circuitry can electrically couple with the switch. The auto-adjusting resonant circuitry can electrically couple with an induction coil of the induction warming system. The auto-adjusting resonant circuitry can control a voltage level of an energy storage device prior to activation of the switch. The energy storage device can provide electrical power to the induction coil with the switch deactivated. The auto-adjusting resonant circuitry can prevent, responsive to controlling the voltage level of the energy storage device, charging of the energy storage device by the switch responsive to activation of the switch.

In some embodiments, the auto-adjusting resonant circuitry can include first circuitry. The first circuitry can couple with a power source. The first circuitry can receive a first voltage included in an alternating current (AC) signal. The first circuitry can convert the AC signal to a direct current (DC) signal. The auto-adjusting resonant circuitry can include second circuitry. The second circuitry can activate the switch to power the induction coil based on the DC signal. The auto-adjusting resonant circuitry can include third circuitry. The third circuitry can control a voltage difference between the voltage level of the energy storage device and the second circuitry prior to controlling the switch to prevent charging of the energy storage device by the switch.

In some embodiments, the second circuitry can deactivate the switch subsequent to a predetermined amount of time. The induction coil can discharge power from the energy storage device causing a decrease in the voltage level of the energy storage device. The third circuitry can charge the energy storage device to offset the decrease in the voltage level of the energy storage device.

In some embodiments, the induction coil can provide current, via a first path, to the energy storage device to charge the energy storage device responsive to deactivation of the switch. The energy storage device can serve as a voltage source responsive to a predetermined amount of time subsequent to deactivation of the switch.

In some embodiments, the auto-adjusting resonant circuitry can provide current to the induction coil via a first path with the switch activated. The auto-adjusting resonant circuitry can provide current to the induction coil via a second path with the switch deactivated. The first path can include current flowing through the switch. The second path can include current flowing through the energy storage device.

In some embodiments, the auto-adjusting resonant circuitry can operate such that a maximum power output provided, by a power source, to the auto-adjusting resonant circuitry is no more than 15% larger than an average power output provided, by the power source, to the auto-adjusting resonant circuitry.

In some embodiments, the auto-adjusting resonant circuitry can operate at a continuous load such that a change in an amount of power, provided by a power source to the auto-adjusting resonant circuitry, is prevented from causing a change in current flowing through the induction coil.

In some embodiments, the induction coil can receive, from the auto-adjusting resonant circuitry, current via a first path with the switch activated. The induction coil can receive, from the auto-adjusting resonant circuitry, current via a second path with the switch deactivated.

At least one embodiment relates to an auto-adjusting resonant circuitry. The auto-adjusting resonant circuitry can be for induction warming. The auto-adjusting resonant circuitry can electrically couple with an induction coil and a switch. The auto-adjusting resonant circuitry can control a voltage level of an energy storage device prior to activation of the switch. The energy storage device can provide electrical power to the induction coil with the switch deactivated. The auto-adjusting resonant circuitry can prevent, responsive to controlling the voltage level of the energy storage device, charging of the energy storage device by the switch responsive to activation of the switch.

In some embodiments, the auto-adjusting resonant circuitry can include first circuitry. The first circuitry can couple with a power source. The first circuitry can receive a first voltage included in an alternating current (AC) signal. The first circuitry can convert the AC signal to a direct current (DC) signal. The auto-adjusting resonant circuitry can include second circuitry. The second circuitry can activate the switch to power the induction coil based on the DC signal. The auto-adjusting resonant circuitry can include third circuitry. The third circuitry can control a voltage difference between the voltage level of the energy storage device and the second circuitry prior to controlling the switch to prevent charging of the energy storage device by the switch.

In some embodiments, the auto-adjusting resonant circuitry can provide current to the induction coil via a first path with the switch activated. The auto-adjusting resonant circuitry can provide current to the induction coil via a second path with the switch deactivated. The first path can include current flowing through the switch. The second path can include current flowing through the energy storage device.

In some embodiments, the auto-adjusting resonant circuitry can operate such that a maximum power output provided, by a power source, to the auto-adjusting resonant circuitry is no more than 15% larger than an average power output provided, by the power source, to the auto-adjusting resonant circuitry.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a block diagram of an induction warming system, according to an exemplary embodiment.

FIG. 2 is a block diagram of circuitry included in the induction warming system illustrated in FIG. 1, according to an exemplary embodiment.

FIG. 3 is a schematic diagram of one or more components included in the induction warming system illustrated in FIG. 1, according to an exemplary embodiment.

FIG. 4 is a schematic diagram illustrating operation of the one or more components illustrated in FIG. 3, according to an exemplary embodiment.

FIG. 5 is a schematic diagram illustrating operation of the one or more components illustrated in FIG. 3, according to an exemplary embodiment.

FIG. 6 is a schematic diagram illustrating operation of the one or more components illustrated in FIG. 3, according to an exemplary embodiment.

FIG. 7 is a schematic diagram illustrating operation of the one or more components illustrated in FIG. 3, according to an exemplary embodiment.

FIG. 8 is a schematic diagram illustrating operation of the one or more components illustrated in FIG. 3, according to an exemplary embodiment.

FIG. 9 is a graph illustrating one or more signals associated with operation of one or more components of the induction warming system illustrated in FIG. 1, according to an exemplary embodiment.

FIG. 10 is a graph illustrating one or more signals associated with operation of one or more components of the induction warming system illustrated in FIG. 1, according to an exemplary embodiment.

FIG. 11 is a graph illustrating one or more signals associated with operation of one or more components of the induction warming system illustrated in FIG. 1, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the figures, an induction warming system is shown, according to various embodiments. The induction warming system includes a variable power supply, an induction heating element/coil, an energy exchange inductor, a semiconductor switching element, and gate drive and control. The variable supply is converted to a constant voltage by a bridge rectifier. The semiconductor switch is controlled by the gate drive and control subassembly. The gate drive turns on the induction heating element/coil which is powered by the DC supply.

Other induction warming systems may include a single switch power conversion topology that operates with hard switching across the main switch component. These systems are prone to power losses and overheating at high-frequency operation, among other hardware issues caused by hard switching. As a result, many of these induction warming systems will have to operate with a duty cycle which pulses the induction warming system between being on and off such that the average power output approaches a desired power output. The gate control for the switch will pulse at a power level higher than desired and duty cycle these pulses to achieve an average power level lower than the pulsed power level. As an example, if the target output is 500 watts, other induction warming system may operate a duty cycle which switches between being off (e.g., 0 watts, near 0 watts, etc.) and providing 1,000 watts (while on) such that the average power output is 500 watts. However, in this example, the actual power output is not 500 watts but rather the average is 500 watts. Stated otherwise, the induction systems operates at a wattage that is higher/larger than a target output.

Operating a duty cycle such that a power source switches between being off and providing a power output (which higher than a desired output) may refer to or include operating in a burst mode. Operating in a burst mode allows the switch to experience lower current spikes from hard switching, but the burst mode causes cooking issues for the induction warming system. For example, operating at a wattage level (that is larger than the target wattage) results in a larger and/or greater temperature rise than desired. Moreover, in order to reach the target wattage, via burst mode, the heating element is switched between being active and inactive which results in an irregular heating pattern. The irregular heating pattern is not desired as the irregular heating pattern allows for food to get cold and then hot again. Consequently, the irregular heating pattern may result in wasting food and/or sub-optimally heating the induction coil.

Some technical solutions described herein include circuitry to discharge capacitors that may otherwise subject an induction warming system to hard switching. The discharging of the capacitors may reduce or eliminate hard switching by controlling a voltage difference between the capacitors and one or more switches. Moreover, the circuity may operate at low load without operating in a burst mode to control an average power output in an induction warming system. Without hard switching, the single switch component can operate without large current spikes, which saves energy, reduces the heat dissipated through the switch, and allows the switch to last longer. Furthermore, the lack of a burst mode means that food can be heated consistently, without allowing food to become too hot or too cold.

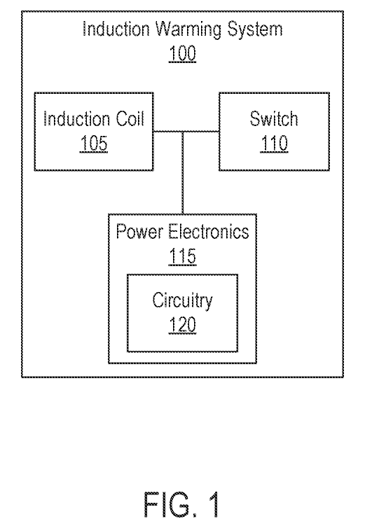

FIG. 1 depicts a block diagram of an induction warming system 100, according to an exemplary embodiment. In some embodiments, the induction warming system 100 may be a warming device to provide induction to a food receptacle. The induction warming system 100 includes an induction coil 105, a switch 110 (e.g., a switching device), and power electronics 115.

In some embodiments, the switch 110 may include one or more switching devices. For example, the switch 110 may include relays, contactors, transistors, and/or other possible controllable elements. In some embodiments, the switch 110 may be electrically coupled with one or more components of the induction warming system 100. For example, the switch 110 may be electrically coupled with the power electronics 115. As another example, the switch 110 may be couple with one or more resistive elements (e.g., resistors, inductors, capacitors, etc.). In some embodiments, the switch 110 may control or dictate a supply of electrical power to the induction coil 105. For example, the switch 110 may electrically decouple the induction coil 105 from a power supply. As another example, the switch 110 may electrically couple one or more components and/or circuitry of the induction warming system 100 with the induction coil 105.

In some embodiments, the switch 110 may include any device that can selectively provide a path for electric power flow, such as a semiconductor device (e.g., insulated-gate bipolar transistor (IGBT), metal-oxide semiconductor field-effect transistor (MOSFET), bipolar junction transistor (BJT)), relay, or the like. In some embodiments, the power electronics 115 may drive and/or otherwise control the switch 110. For example, the power electronics 115 may transmit a first signal to activate (e.g., open and/or close) the switch. As another example, the power electronics 115 may transmit a second signal to deactivate the switch. In some embodiments, the power electronics 115 may include or more circuitry 120. For example, the power electronics 115 may include first circuitry, second circuitry, etc. to control operation of the switch 110 and/or one or more components of the induction warming system 100.

In some embodiments, the induction coil 105 may include one or more warming elements for the induction warming system 100. In some embodiments, the induction coil 105 may warm, excite, and/or otherwise heat at least one receptacle. For example, the induction coil 105 may produce heat, via one or more inductive elements, to warm a pan (e.g., a receptacle). In some embodiments, the induction coil 105 may include any type of induction coil to provide and/or create a magnetic field to heat a desired receptacle.

In some embodiments, the power electronics 115 may refer to and/or include auto-adjusting resonant circuitry. The power electronics 115 may control a voltage level of an energy storage device prior to activation of the switch 110. For example, the power electronics 115 may control a voltage difference between a capacitor and the switch 110. As another example, the power electronics 115 may control the voltage by discharging an energy storage device. In some embodiments, the energy storage device may provide electrical power to the induction coil 105 with the switch 110 deactivated. For example, the power electronics 115 may include an inductor, which may ground and discharge a capacitor that provides power to the induction coil 105. In this example, the switch 110, when reactivated, will not experience circuity complications (e.g., hard switching, heating irregularity, etc.) that results from charging the capacitor to common voltage.

In some embodiments, the power electronics 115 may prevent charging of the energy storage device. For example, the power electronics 115 may prevent charging of the energy storage that results from activation of the switch 110. To continue this example, the power electronics 115 may control the voltage level of a capacitor prior to activation of the switch 110 such the voltage level of the capacitor is at or near a common voltage. Stated otherwise, a voltage difference between the voltage at the switch 110 and the capacitor is minimal such that activation of the switch 110 does not cause a current spike to bring the voltage level of the capacitor to common.

In some embodiments, the power electronics 115 may operate at one or more continuous loads or outputs. For example, the power electronics 115 may receive a continuous amount of power (e.g., a power output, an amount of electrical energy, etc.) from a power source. As another example, the power electronics 115 may receive a power output which does not fluctuate and/or deviate such that the power electronics 115 operate without a burst mode. Stated otherwise, the power electronics 115 may receive 300 watts, from the power supply, as a continuous supply. In some embodiments, the power electronics 115 may receive a maximum output, from the power source, that is within a given range of an average output. For example, the maximum power output (from the power sources) may be no more than 15% larger than an average power output from the power sources. As another example, the maximum power output may be within 10%-20% of the average power output.

In some embodiments, the power electronics 115 may operate at or provide one or more loads. For example, the power electronics 115 may continuously operate at one or more loads between 7 watts and 1800 watts. As another example, the power electronics 115 may continuously operate at least one or more loads between 300 watts and 1500 watts. In some embodiments, the load or draw, from the power electronics 115 may vary or change based on one or more operating settings for the induction warming system 100. For example, the load of the power electronics 115 may be based on a temperature setpoint (e.g., how much heat or energy the coil 105 should provide), whether a receptacle is present on the induction warming system 100, among other factors. Advantageously, the power electronics 115 can operate, between one or more wattage ratings, without hard switching and burst mode. Moreover, as the load increasing, the power electronics 115 can provide resonant operation.

In some embodiments, the power electronics 115 may receive a power output, from the power source, that is within 5% of the average power amount. For example, the power electronics 115 may draw an amount of power which includes or represents an average amount of power provided (e.g., output) by the power sources. As another example, the power electronics 115 may draw one or more power values and/or amounts of power. In some embodiments, the power electronics 115 may operate at a continuous load to maintain an amount of current provided to the induction coil 105. For example, the power electronics 115 may receive a varying amount of power (e.g., a change in power output) from a power source. To continue this example, the power electronics 115 may control any variances associated with the change in power output such that an amount of current flowing through the induction coil 105 is maintained (e.g., prevented from changing). In some embodiments, the power electronics 115 may prevent the change in the current flowing through the induction coil 105 by controlling and/or manipulating one or more energy storage devices to maintain the current.

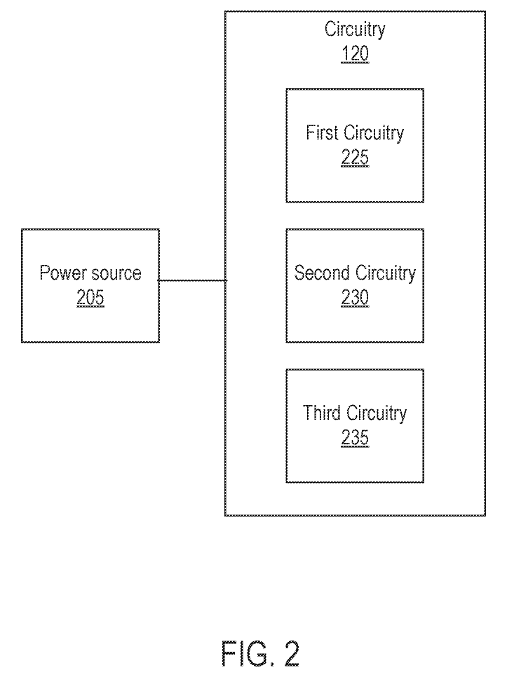

FIG. 2 depicts a block diagram of the circuitry 120, according to an exemplary embodiment. As shown in FIG. 2, the circuitry 120 includes first circuitry 225, second circuitry 230, and third circuitry 235. In some embodiments, the first circuitry 225, the second circuitry 230, and the third circuitry 235 may include electrical components such as, diodes, capacitors, resistors, inductors, switches, batteries, logic gates, and/or other hardware elements.

In some embodiments, the first circuitry 225 may supply a first voltage to the induction warming system 100. For example, the first circuitry 225 may receive electrical power, current, and/or voltage from a power source 205 (e.g., an outlet, the grid, batteries etc.). In some embodiments, the first circuitry 225 may receive a first voltage from the power source 205. For example, the first circuitry 225 may receive an alternating current (AC) signal that includes a voltage level.

In some embodiments, the first circuitry 225 may be electrically coupled to one or more components of the induction warming system 100 by a first terminal and a second terminal. For example, the first circuitry 225 may be coupled with the induction coil 105. As another example, the first circuitry 225 may be coupled with the second circuitry 230. In some embodiments, the first circuitry 225 may include an (AC) voltage supply circuit or a connector configured to supply AC voltage via a building outlet.

In some embodiments, the first circuitry 225 may convert the first voltage from the AC signal to a direct current (DC) signal. For example, the first circuitry 225 may include an AC-DC converter that converts AC signals to DC signals. As another example, the first circuitry 225 may include bridge rectifiers.

In some embodiments, the first circuitry 225 may supply or implement a DC voltage bus for the induction warming system 100. For example, the first circuitry 225 may supply DC voltage that powers the induction coil 105, responsive to activation of the switch 110. As another example, the first circuitry 225 may one or more diodes that direct current flow to provide the DC voltage.

In some embodiments, the second circuitry 230 may power the inductive coil by controlling the switch 110. For example, the second circuitry 230 may provide one or more signals that excites and/or activates the switch 110. As another example, the second circuitry 230 may apply a voltage level and/or current to have the switch 110 open and/or close. In some embodiments, the second circuitry 230 may activate the switch 110 to power the induction coil 105. For example, the second circuitry 230 may close the switch 110 such that current begins to flow to the induction coil 105 to cause the induction coil 105 to produce heat.

In some embodiments, the second circuitry 230 may include a gate drive and control circuit, to apply a voltage across one or more terminals of the switch 110. For example, the second circuitry 230 may include logic devices that control when the switch 110 is activated and/or deactivated. In some embodiments, the gate drive and control circuitry may modify, control, and/or adjust the power supplied to the coil by adjusting and/or controlling the frequency and/or the duration of which the switch 110 is activated.

In some embodiments, the third circuitry 235 may control one or more voltage differences. For example, the third circuitry 235 may control a voltage difference between a voltage level of a capacitor (e.g., an energy storage device) and the second circuitry 230. To continue this example, the third circuitry 235 may control the voltage difference to prevent hard switching that results from activation of the switch 110. Stated otherwise, the third circuitry 235 may prevent charging of the energy storage device immediately after activation of the switch.

In some embodiments, the third circuitry 235 may include one or more parasitic elements. For example, the third circuitry 235 may include an inductor to prevent to discharge of the energy storage device after deactivation and/or prior to activation of the switch 110. As another example, the inductor may ground the energy storage device in the induction warming system 100 to discharge the energy storage device to a common voltage. In some embodiments, the third circuitry 235 may prevent current spikes that otherwise may causes an increase in thermal energy within the switch 110.

In some embodiments, the second circuitry 230 may deactivate the switch subsequent to a predetermined amount of time. For example, the second circuitry 230 may deactivate the switch 110 responsive to the switch 110 having been active for 10 milliseconds. As another example, the second circuitry 230 may deactivate the switch 110 based on a temperature of the induction coil 105. As another example, the switch 110 may operate at a frequency of 20 kilohertz, which causes the switch to deactivate/activate in 10 microsecond intervals.

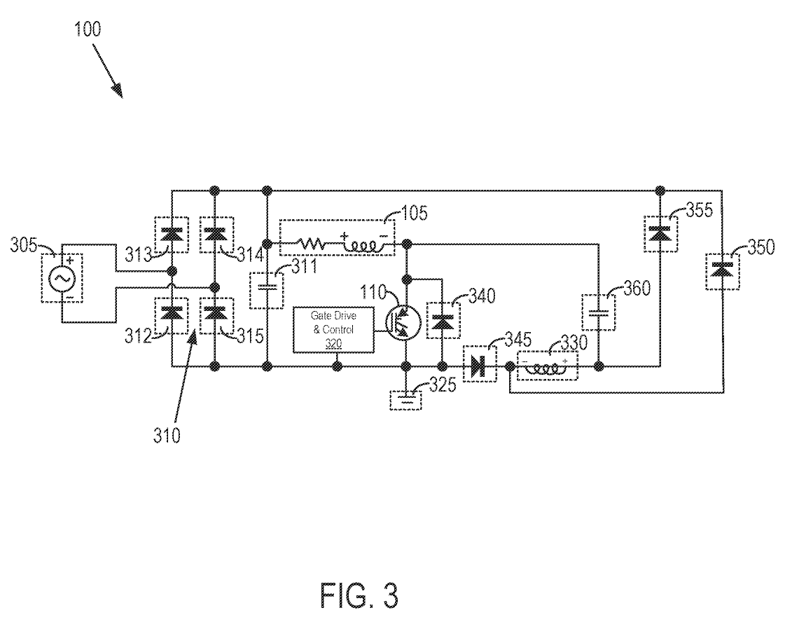

FIG. 3 depicts a schematic diagram of one or more components included in the induction warming system 100, according to an exemplary embodiment. For example, the schematic diagram illustrated in FIG. 3, provides an example one or more electrical components included in the induction warming system 100. While FIG. 3 may illustrate one or more components as certain electrical components, this is for illustrative purposes only and is in no way limiting. For example, a first component that is shown as a first type of electrical component may be replaced with a second component that is a second type of electrical component. In some embodiments, the components of the schematic diagram may include at least one of MOSFETs, transistors, diodes, capacitors, inductors, resistors, relays, IGBTs, Zener diodes, light-emitting diodes, wires, BJTs, transformers, full bridge rectifiers, and/or semiconductor devices.

In some embodiments, the induction warming system 100 may include at least one component 305, at least one component 310, at least one component 311, at least one component 320, at least one component 325, at least one component 330, at least one component 340, at least one component 345, at least one component 350, at least one component 355, and at least one component 360. The various components, as illustrated in FIG. 3, may refer to and/or include at least one of the various devices, circuitry, and/or components described herein. For example, the component 360 may refer to the energy storage device for which the third circuitry 235 regulates. As another example, the component 305 may include the power source 205.

In some embodiments, the various components, as illustrated in FIG. 3, may be electrically coupled with one another. For example, the component 305 may be electrically coupled with the component 310 such that the component 305 may provide electrical power to the component 310. In some embodiments, the components may include one or more arrangements and/or configurations. For example, the components may be in series relative to one another. As another example, the components may be in parallel relative to one another.

As non-limiting examples, the component 305 is shown as an AC voltage source, the component 310 is shown as a full bridge rectifier (which includes diodes 312, 313, 314, and 315), the component 311 is shown as a smoothing capacitor, the component 320 is shown as the gate drive and control 320, the component 325 is shown as common, the component 330 is shown as an inductor, the components 340, 345, 350, and 355 are shown as diodes, and the component 360 is shown as a capacitor.

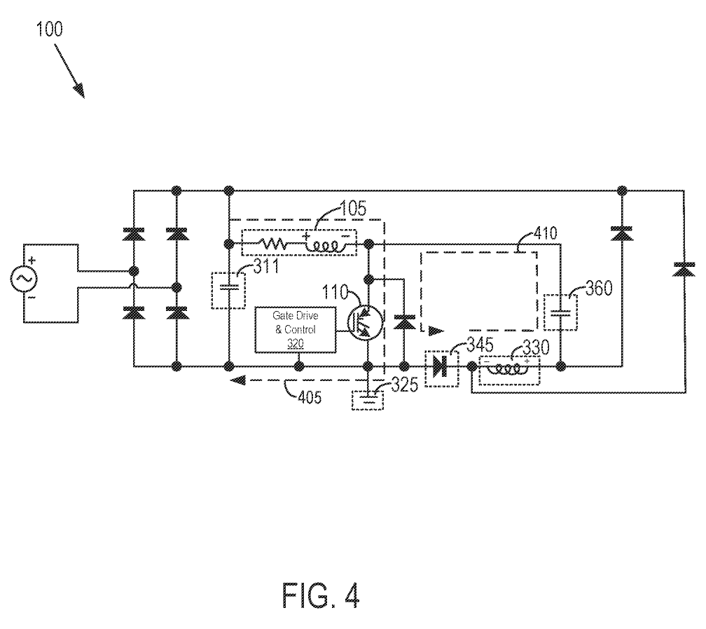

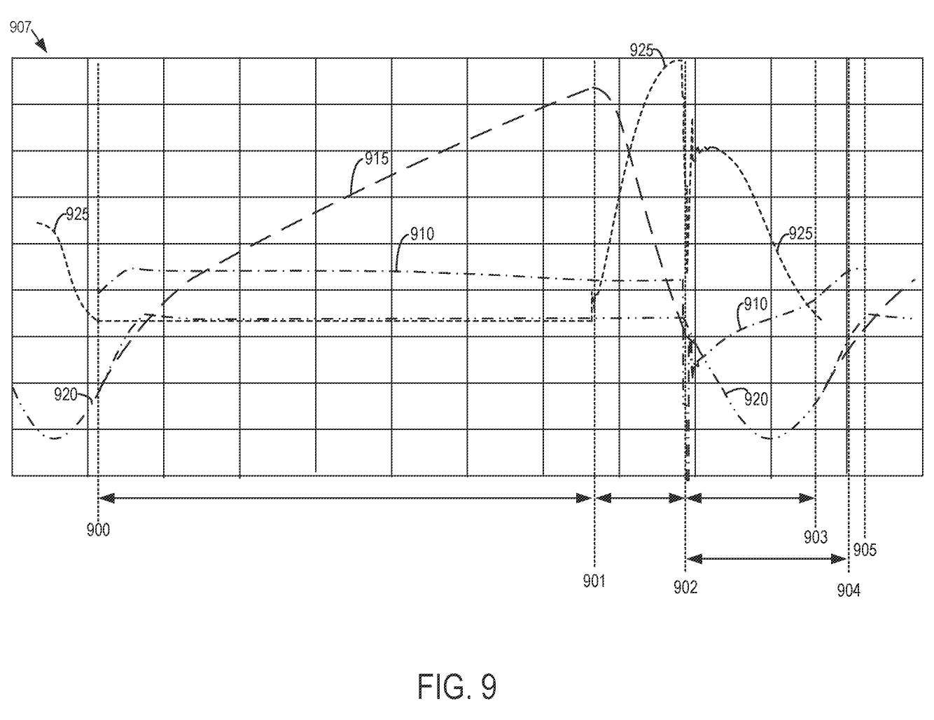

FIG. 4 is a schematic diagram illustrating operation of the one or more components illustrated in the FIG. 3, according to exemplary embodiment. In some embodiments, FIG. 4 depicts an exemplary operation of the induction warming system 100 which illustrates operation of the induction warming system 100 from a time T0 just prior to and/or at activation of the switch 110 to a predetermined amount of time after activation of the switch 110 (time T1). This operation is further described with reference to FIG. 9). At time T0, the gate drive and control 320 may turn on (e.g., apply a voltage to the switch 110). The application of the voltage to the switch 110 may cause current to flow from the component 311 to the induction coil 105 (illustrated by path 405 in FIG. 4).

The current, represented by the path 405, may continue to flow from the induction coil 105 to the switch 110 and then to the component 325. The flow of current may continue until time T1, upon which the switch 110 may be deactivated. For example, the gate drive and control 320 may stop and/or halt an application of voltage to the switch 110. Stated otherwise, the gate drive and control 320 may apply a voltage to the switch 110 from time T0 to time T1. In some embodiments, the flow of current represented by the path 405 may increase withing the induction coil 105 which causes the induction coil 105 to produce heat.

In some embodiments, current may also flow along a second path 410 from the component 360, to the component 330. The second path 410 may represent operation at lower loads (e.g., less than 100 watts, less than 500 watts, etc.). In some embodiments, when the component 330 includes a reactance magnitude equal to that of the component 360, the flow of current in accordance to the second path 410 may oscillate between the component 330 and the component 360 at a frequency (e.g., resonant frequency). Stated otherwise, the components 330 and 360 may operate in resonance and as a result will pose minimal impedance and provide a greater current flow at a resonant frequency.

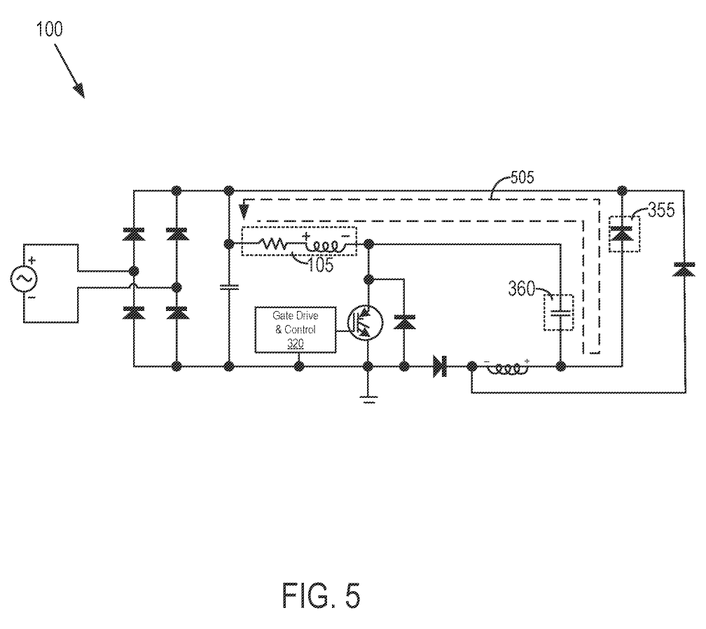

FIG. 5 is a schematic diagram illustrating operation of the one or more components illustrated in the FIG. 3, according to exemplary embodiment. In some embodiments, FIG. 5 depicts an exemplary operation of the induction warming system 100 from time T1 (e.g., just after deactivation of the switch 110) to a predetermined amount of time after deactivation of the switch 110 (e.g., time T2). At time T1, the gate drive and control 320 may deactivate the switch 110. For example, the gate drive and control 320 may stop an application of voltage to the switch 110. Stated otherwise, the gate drive and control 320 may not apply a voltage across one or more terminals of the switch 110 from time T1 to time T2, thus keeping the switch 110 deactivated.

As shown in FIG. 5, when the switch 110 is deactivated, the voltage across the switch 110 may increase which could causes energy to transfer to the component 360. The current may flow in a path 505 through the induction coil 105, the component 360, and the component 355. The current represented by the path 505 may increase within the induction coil 105 and produce heat. In some embodiments, the current in the induction coil 105 may continue to increase until the voltage level of the switch 110 is greater than the voltage level of the component 360. Once the voltage level of the switch 110 exceeds the voltage level of the component 360, the current through the induction coil 105 may then decrease.

While some of the figures may indicate or illustrate a polarity for one or more elements or components, this is for illustrative purposes only and is in no way limiting. For example, a polarity of an inductor may be dependent on a flow or directionality of current such that the polarity of the inductor changes as a result of a change in direction of the current.

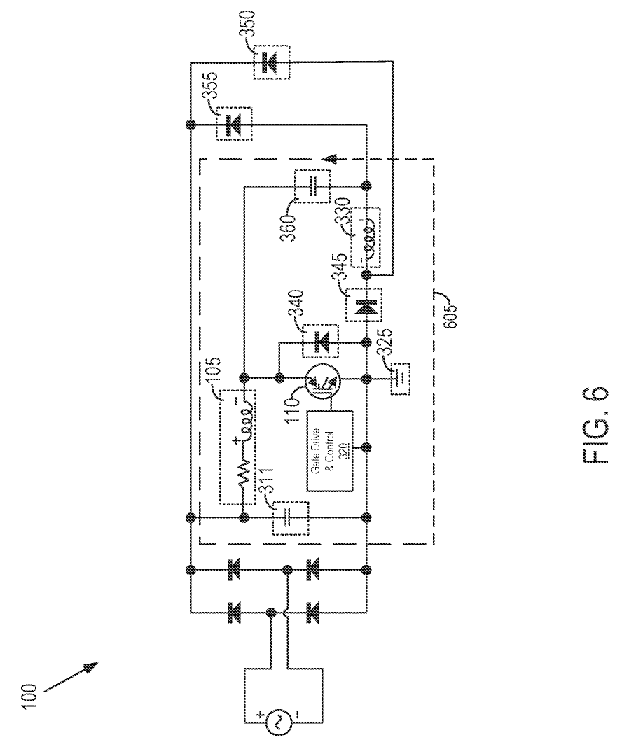

FIG. 6 is a schematic diagram illustrating operation of the one or more components illustrated in the FIG. 3, according to exemplary embodiment. In some embodiments, FIG. 6 depicts an exemplary operation of the induction warming system 100 from the time T2 to a time where the switch is still deactivated (e.g., time T3). Stated otherwise, FIG. 6 depicts an example of operation of the induction warming system 100 continuing to operate (From time T2 to time T3) while the switch 110 is deactivated. At time T2, the current of through the induction coil 105 be at and/or near zero amps such that the component 355 is no longer conducting. The component 355 no longer conducting causes a voltage decrease (e.g., a voltage dip) at the switch 110 and also causes current to being flowing in the component 330, illustrated by path 605 in FIG. 6.

In some embodiments, the component 360 may begin to serve as a voltage source and current will flow in an opposite direction (e.g., relative to the path 505 and/or the path 405). The current may continue to flow along the path 605 through the induction coil 105, the component 360, the component 345, and the component 330, and then back to the induction coil 105. In some embodiments, the component 330 may continue to discharge the component 360 by the path 605 until the voltage level of the switch 110 causes the component 340 to conduct causing the voltage level of the switch 110 to clamp too common.

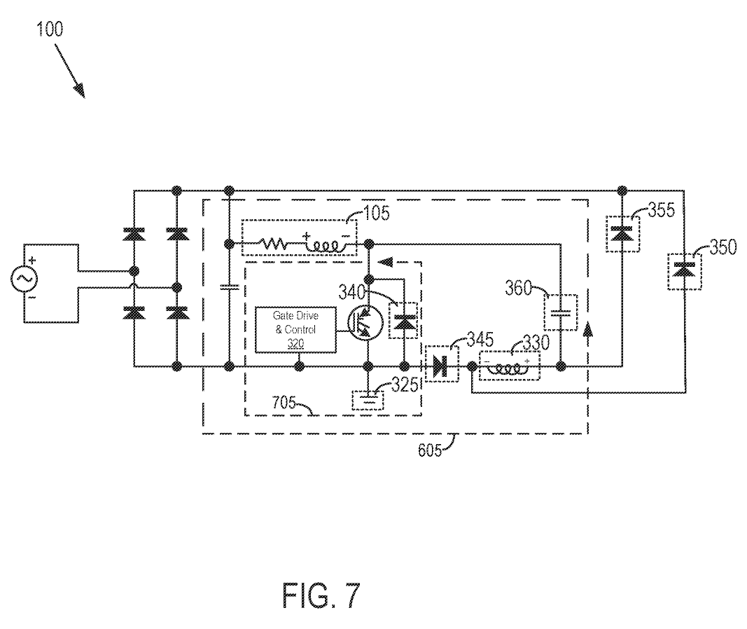

FIG. 7 is a schematic diagram illustrating operation of the one or more components illustrated in FIG. 3, according to exemplary embodiment. In some embodiments, FIG. 7 depicts an exemplary operation of the induction warming system 100 from the time T3 to until a time where reactivation of the switch 110 occurs (e.g., a time T4). Stated otherwise, FIG. 7 depicts an example of the induction warming system 100 operating from the clamping of the component 340 (e.g., time T3) until reactivation of the switch 110 (e.g., time T4). From the time T3 to the time T4, the gate drive and control 320 does not apply a voltage across the terminals of the switch 110, thus causing the switch 110 to be deactivated.

From time T3 to T4 current may continue to flow through a path 605 through the induction coil 105, the component 311, the component 345, the component 330, the component 360, and then back to the induction coil 105. In some embodiments, the induction coil may discharge the component 360 to common, and the component 330 may charge the component 360 to the bus voltage. Stated otherwise, the component 330 may offset the decrease (e.g., discharge) of the voltage level of the component 360 by charging the component 360 to the bus voltage. The discharging of the component 360 and the subsequent charging of the component 360 may assist in preventing hard switching upon activation of the switch 110.

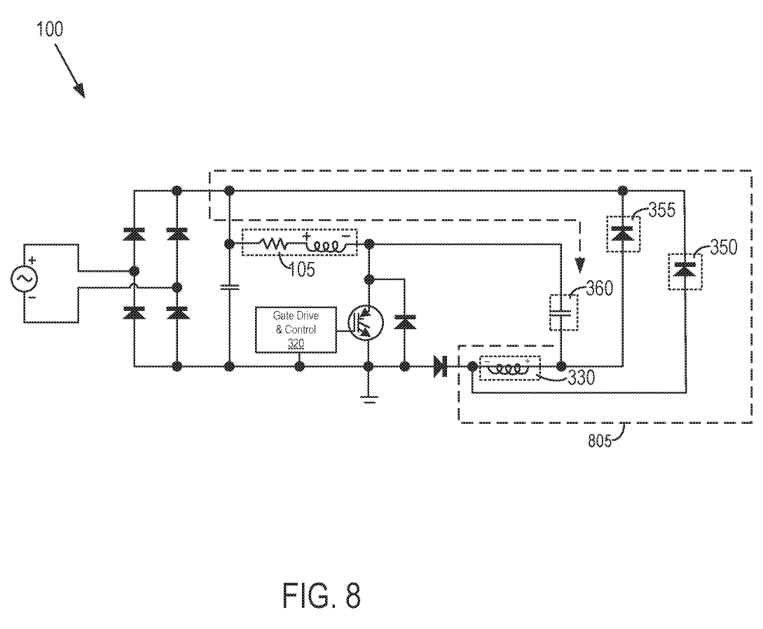

FIG. 8 is a schematic diagram illustrating operation of the one or more components illustrated in FIG. 3, according to exemplary embodiment. In some embodiments, FIG. 8 depicts an exemplary operation of the induction warming system 100 from the time T4 until a time at which the gate drive and control 320 begins to apply a voltage across the terminals of the switch 110, thus reactivating the switch 110 . From time T4 to T5 current may flow along path 805 through the induction coil 105, the component 360, the component 330, the component 350, and then back to the induction coil 105. At time T5, the capacitor is charged negative to positive in the direction of the path 805. In some embodiments, current may flow through the component 355 and the component 340 until the current (through the component 330) decreases to zero amps.

FIG. 9 depicts a graph 907 illustrating one or more signals associated with the operation of the induction warming system 100, according to exemplary embodiment. In some embodiments, the graph 907 may correspond to an application of a high load (e.g., in excess of 1000 watts) by the component 305. The various signals illustrated in FIG. 9 may correspond to and/or indicate current and/or volage levels of corresponding components of the induction warming system 100.

In some embodiments, signal 925 is associated with the voltage across the collector and emitter terminals of the switch 110. Signal 910 is associated with the voltage at the anode of component 355 referenced to the component 325 or the voltage across the component 360. Signal 915 is associated with the current through the induction coil 105. Signal 920 is associated with the current through at least one of the component 105, the component 330, and/or the component 360.

In some embodiments, line 900 may represent and/or refer to the time T0 described herein. Additionally and/or alternatively, line 901 may represent the time T1 described herein. Stated otherwise, the line 900 and the line 901 may represent various signals that result from the operation of the induction warming system 100 as described with reference to FIG. 4.

As shown in FIG. 9, at line 900, the signal 925 is near zero. Stated otherwise, the voltage of the switch 110 is zero. In some embodiments, the voltage level of the switch 110 may prevent hard switching. For example, the switch 110 may be activated without the negative effects of switching while a voltage is still present across the collector and emitter. In some embodiments, the voltage level of the switch may be due to the induction coil 105 having discharged the component 360 to common.

In some embodiments, at the line 900, the switch 110 may be activated. For example, the gate drive and control 320 may apply a voltage to one or more terminals of the switch 110 to activate the switch 110. As shown in FIG. 9, the current through the induction coil 105 (as indicated by the signal 915) may increase as a result of the activation of the switch 110. Additionally, as indicated by the signal 920, the current may not flow in a secondary path through the component 330. In some embodiments, the current flows from the line 900 to the line 901 may follow path 405. The line 901 may represent and/or indicate deactivation of the switch 110. For example, the line 901 may represent when the gate drive and control 320 stops applying a voltage to the switch 110.

In some embodiments, line 902 may represent the time T2 described herein. Stated otherwise, the line 901 and the line 902 may represent various signals that result from the operation of the induction warming system 100 as described with reference to FIG. 5. At the line 901, the switch 110 is turned off. The voltage across the switch 110 may increase which causes current to flow through the induction coil 105 (e.g., current flows in accordance with the path 505). The current through the induction coil 105 will continue to increase until the voltage across the switch 110 exceeds the voltage of the component 311.

Once the voltage across the switch 110 exceeds the voltage of the component 311, the current in the induction coil 105 decreases even though the voltage across the switch 110 continues to increase. For example, the signal 915 is shown to decrease from the line 901 to the line 902. As another example, the signal 925 is shown to increase from the line 901 to the line 902.

In some embodiments, line 903 may represent the time T3 described herein. Stated otherwise, the line 902 and the line 903 may represent various signals that result from the operation of the induction warming system 100 as described with reference to FIG. 6. At the line 902, the current through the induction coil 105 (e.g., the signal 915) is shown to be zero. At this point, the voltage of the component 360 is equal to the peak voltage across the switch 110 minus a bus voltage, and minus the voltage drop across component 330. Moreover, at this point, the voltage across the component 360 minus the voltage on the component 311 can be dropped across the component 105 and the component 330.

In some embodiments, the component 355 quits conducting, which causes the switch 110 voltage to drop, depicted by signal 925. Current begins flowing in the component 330, as depicted by signal 920. Additionally, the signal 910 illustrates that the component 360 begins to act as a voltage source and current flows opposite of the induction coil 105. In some embodiments, the component 330 may discharge the component 360 until the voltage across switch 110 reaches zero. In some embodiments, the various signals illustrated between the line 902 and the line 903 may correspond to the path 605.

In some embodiments, line 904 may represent the time T4 described herein. Stated otherwise, the line 903 and the line 904 may represent various signals that result from the operation of the induction warming system 100 as described with reference to FIG. 7. At the line 903, the current through the induction coil 105 continues to decrease and may reach zero at line 904, as shown by signal 915. In some embodiments, the component 330 may charge the component 360 to Vbus (e.g., DC voltage across the component 311). Additionally, and/or alternatively the induction coil 105 may discharge the component 360 to common.

In some embodiments, line 905 may represent the time T5 described herein. Stated otherwise, the line 904 and the line 905 may represent various signals that result from the operation of the induction warming system 100 as described with reference to FIG. 8. At the line 905, the voltage of the component 360 may represent the voltage just prior to activation of the switch 110. Stated otherwise, the voltage of the component 360 is such that activation of the switch 110 does not result in any hard switching.

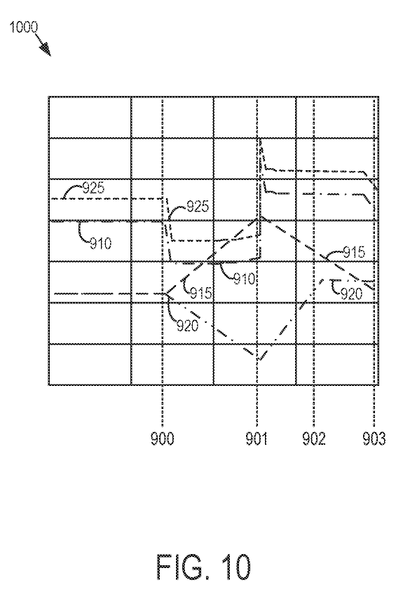

FIG. 10 depicts a graph 1000 illustrating one or more signals associated with the operation of the induction warming system 100, according to exemplary embodiment. In some embodiments, the graph 1000 may illustrate the induction warming system 100 operating at low load (e.g., loads less than 100 watts). The signal 925 is associated with the voltage across the collector and emitter terminals of the switch 110. The signal 910 is associated with the voltage at the anode of the component 355 referenced to the component 325 or the voltage across the component 360. The signal 915 is associated with the current through induction coil 105. The signal 920 is associated with the current through the component 330, which is inverted on graph 907.

In some embodiments, the line 900 to the line 901 may represent the time T0 to the time T1. At the line 900, the switch 110 may turn on (e.g., activated), which may cause the current in the induction coil 105 to increase. The current through the component 330 is also shown to increase. In some embodiments, the current through the induction coil 105 may flow in accordance with the path 405. The current may also flow through the inductor 330.

In some embodiments, the line 901 to the line 902 may represent the time T1 to the time T2. At the line 901, the switch 110 may be turned off (e.g., deactivated) and the voltage of the switch 110 may continue to increase. In some embodiments, the current through the induction coil 105 may flow in accordance with the path 505. The current may flow through diode 354, the inductor 330, and then through the diode 355 at the same time as current flows through the path 505.

In some embodiments, the line 902 to the line 903 may represent the time T2 to the time T3. For example, the line 902 to the line 903 may represent the operation of the induction warming system 100 as described with reference to FIG. 6. Stated otherwise, the signals illustrated between the line 902 and the line 903 may correspond to the path 605.

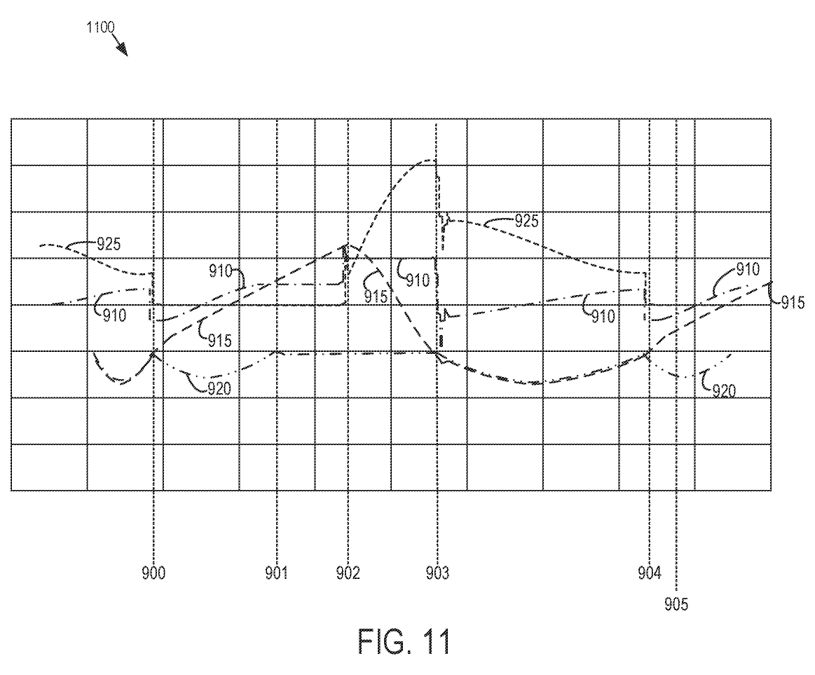

FIG. 11 depicts a graph 1100 illustrating one or more signals associated with the operation of the induction warming system 100, according to exemplary embodiment. In some embodiments, the graph 1100 may correspond to an application of a medium load (e.g., in excess of 100 watts and less than 1000 watts) by the component 305. The various signals illustrated in FIG. 11 may correspond to and/or indicate current and/or volage levels of corresponding components of the induction warming system 100.

In some embodiments, signal 925 is associated with the voltage across the collector and emitter terminals of the switch 110. Signal 910 is associated with the voltage at the anode of component 355 referenced to the component 325 or the voltage across the component 360. Signal 915 is associated with the current through the induction coil 105. Signal 920 is associated with the current through the component 330 and/or the current through the induction coil 105.

In some embodiments, line 900 may represent and/or refer to the time T0 described herein. Additionally and/or alternatively, line 901 may represent the time T1 described herein. Stated otherwise, the line 900 and the line 901 may represent various signals that result from the operation of the induction warming system 100 as described with reference to FIG. 4.

At the line 900, the switch 110 turns on (e.g., activated) and current is shown to flow from the component 311 to the induction coil 105 and then to the switch 110. At the line 901, the switch 110 is still shown as on (e.g., activated).

At line 902, the switch 110 is turned off (e.g., deactivated). The voltage across the switch 110 continues to increase and energy is transferred from the switch 110 to the component 360. Current flows from the induction coil 105 to the component 360 in accordance with the path 505. The current through the induction coil 105 continues to increase until the voltage across the switch 110 exceeds the voltage of the component 311.

At line 903, the current through the induction coil 105 decreases to zero. At this point, the voltage on the component 360 is equal to the voltage across the switch 110 minus a bus voltage. The bus voltage may refer to or include the voltage across the switch 110 minus the voltage across the component 311. Given that the current in the induction coil 105 is zero, the component 355 quits conducting, which causes a voltage dip on the switch 110. The energy in the component 360 is now a voltage source and current will now flow from the component 360 to the induction coil 105 in accordance with the path 605.

As utilized herein with respect to numerical ranges, the terms “approximately,” “about,” “substantially,” and similar terms generally mean +/- 10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent, or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the induction warming system 100 and the systems and components thereof as shown in the various exemplary embodiments is illustrative only. Additionally, any element disclosed in one embodiment may be incorporated or utilized with any other embodiment disclosed herein.

What is claimed is:

1. An induction warming system, comprising:
an induction coil;
a switch; and
an auto-adjusting resonant circuitry coupled to the induction coil and the switch, the auto-adjusting resonant circuitry configured to:
control a voltage level of an energy storage device prior to activation of the switch, the energy storage device configured to provide electrical power to the induction coil with the switch deactivated; and
prevent, responsive to controlling the voltage level of the energy storage device, charging of the energy storage device by the switch responsive to activation of the switch.

2. The induction warming system of claim 1, wherein the auto-adjusting resonant circuitry includes:
first circuitry coupled with a power source, the first circuitry configured to:
receive a first voltage included in an alternating current (AC) signal; and
convert the AC signal to a direct current (DC) signal;
second circuitry configured to activate the switch to power the induction coil based on the DC signal; and
third circuitry configured to control a voltage difference between the voltage level of the energy storage device and the second circuitry prior to controlling the switch to prevent charging of the energy storage device by the switch.

3. The induction warming system of claim 2, comprising:
the second circuitry configured to deactivate the switch subsequent to a predetermined amount of time;
the induction coil to discharge power from the energy storage device causing a decrease in the voltage level of the energy storage device; and
the third circuitry configured to charge the energy storage device to offset the decrease in the voltage level of the energy storage device.

4. The induction warming system of claim 1, comprising:
the induction coil to provide current, via a first path, to the energy storage device to charge the energy storage device responsive to deactivation of the switch; and
the energy storage device configured to serve as a voltage source responsive to a predetermined amount of time subsequent to deactivation of the switch.

5. The induction warming system of claim 1, comprising the auto-adjusting resonant circuitry configured to:
provide current to the induction coil via a first path with the switch activated; and
provide current to the induction coil via a second path with the switch deactivated;
wherein the first path includes current flowing through the switch; and
wherein the second path includes current flowing through the energy storage device.

6. The induction warming system of claim 1, comprising the auto-adjusting resonant circuitry configured to:
operate such that a maximum power output provided, by a power source, to the auto-adjusting resonant circuitry is no more than 15% larger than an average power output provided, by the power source, to the auto-adjusting resonant circuitry.

7. The induction warming system of claim 1, comprising the auto-adjusting resonant circuitry configured to:
operate at a continuous load such that a change in an amount of power, provided by a power source to the auto-adjusting resonant circuitry, is prevented from causing a change in current flowing through the induction coil.

8. The induction warming system of claim 1, comprising the induction coil configured to:
receive, from the auto-adjusting resonant circuitry, current via a first path with the switch activated; and
receive, from the auto-adjusting resonant circuitry, current via a second path with the switch deactivated.

9. A device for an induction warming system, the device comprising:
a switch; and
an auto-adjusting resonant circuitry electrically coupled with the switch, the auto-adjusting resonant circuitry configured to:
electrically couple with an induction coil of the induction warming system;
control a voltage level of an energy storage device prior to activation of the switch, the energy storage device configured to provide electrical power to the induction coil with the switch deactivated; and
prevent, responsive to controlling the voltage level of the energy storage device, charging of the energy storage device by the switch responsive to activation of the switch.

10. The device of claim 9, wherein the auto-adjusting resonant circuitry includes:
first circuitry coupled with a power source, the first circuitry configured to:
receive a first voltage included in an alternating current (AC) signal; and
convert the AC signal to a direct current (DC) signal;
second circuitry configured to activate the switch to power the induction coil based on the DC signal; and
third circuitry configured to control a voltage difference between the voltage level of the energy storage device and the second circuitry prior to controlling the switch to prevent charging of the energy storage device by the switch.

11. The device of claim 10, comprising:
the second circuitry configured to deactivate the switch subsequent to a predetermined amount of time;
the induction coil to discharge power from the energy storage device causing a decrease in the voltage level of the energy storage device; and
the third circuitry configured to charge the energy storage device to offset the decrease in the voltage level of the energy storage device.

12. The device of claim 9, comprising:
the induction coil to provide current, via a first path, to the energy storage device to charge the energy storage device responsive to deactivation of the switch; and
the energy storage device configured to serve as a voltage source responsive to a predetermined amount of time subsequent to deactivation of the switch.

13. The device of claim 9, comprising the auto-adjusting resonant circuitry configured to:
provide current to the induction coil via a first path with the switch activated; and
provide current to the induction coil via a second path with the switch deactivated;
wherein the first path includes current flowing through the switch; and
wherein the second path includes current flowing through the energy storage device.

14. The device of claim 9, comprising the auto-adjusting resonant circuitry configured to:
operate such that a maximum power output provided, by a power source, to the auto-adjusting resonant circuitry is no more than 15% larger than an average power output provided, by the power source, to the auto-adjusting resonant circuitry.

15. The device of claim 9, comprising the auto-adjusting resonant circuitry configured to:
operate at a continuous load such that a change in an amount of power, provided by a power source to the auto-adjusting resonant circuitry, is prevented from causing a change in current flowing through the induction coil.

16. The device of claim 9, wherein the induction coil is configured to:
receive, from the auto-adjusting resonant circuitry, current via a first path with the switch activated; and
receive, from the auto-adjusting resonant circuitry, current via a second path with the switch deactivated.

17. An auto-adjusting resonant circuitry for induction warming, wherein the auto-adjusting resonant circuitry is configured to:
electrically couple with an induction coil and a switch;
control a voltage level of an energy storage device prior to activation of the switch, the energy storage device configured to provide electrical power to the induction coil with the switch deactivated; and
prevent, responsive to controlling the voltage level of the energy storage device, charging of the energy storage device by the switch responsive to activation of the switch.

18. The auto-adjusting resonant circuitry of claim 17, wherein the auto-adjusting resonant circuitry comprises:
first circuitry coupled with a power source, the first circuitry configured to:
receive a first voltage included in an alternating current (AC) signal; and
convert the AC signal to a direct current (DC) signal;
second circuitry configured to activate the switch to power the induction coil based on the DC signal; and
third circuitry configured to control a voltage difference between the voltage level of the energy storage device and the second circuitry prior to controlling the switch to prevent charging of the energy storage device by the switch.

19. The auto-adjusting resonant circuitry of claim 17, wherein the auto-adjusting resonant circuitry is further configured to:
provide current to the induction coil via a first path with the switch activated; and
provide current to the induction coil via a second path with the switch deactivated;
wherein the first path includes current flowing through the switch; and
wherein the second path includes current flowing through the energy storage device.

20. The auto-adjusting resonant circuitry of claim 17, wherein the auto-adjusting resonant circuitry is further configured to operate such that a maximum power output provided, by a power source, to the auto-adjusting resonant circuitry is no more than 15% larger than an average power output provided, by the power source, to the auto-adjusting resonant circuitry.
